(19) United States
(12) Patent Application Publication
(10) Pub. No.: US 2004/0005925 A1
(43) Pub. Date: Jan. 8, 2004

(54) Machine management system

(75) Inventor: Junichi Yamagishi, Taito-ku (JP)

Correspondence Address: JORDAN AND HAMBURG LLP, 122 EAST 42ND STREET, SUITE 4000, NEW YORK, NY, 10168, US

(73) Assignee: Unirec Co., Ltd., Taito-ku (JP)

(21) Appl. No.: 10/188,387

(22) Filed: Jul. 2, 2002

(51) Int. Cl. G06F 17/00

(52) U.S. Cl. 463/40

(57) ABSTRACT

A machine management system employs a wireless point-of-sale (POS) system and enables shops such as game arcades to be expanded in a wide area at low cost.

The machine management system includes a floor management unit (1A), a POS data management server (17), and a POS database (19). Each game machine (3, 5) under the control of the floor management unit (1A) has a sensor, a data holder to hold data based on an output of the sensor and a machine ID, and a radio unit to transmit the data held in the data holder by radio. The floor management unit (1A) has a radio unit to receive data from each game machine by radio and a processing unit to process the received data according to downloaded application software and data. The floor management unit (1A) or a management company downloads necessary application software from the POS data management server (17) and necessary data from the POS database (19) through the Internet and manages the game machines (3, 5) at any time according to the downloaded application software and data.

### BACKGROUND OF THE INVENTION

1. Field of the Invention

The present invention relates to a machine management system to manage, for example, game machines installed in game arcades.

2. Description of the Related Art

A game arcade has a variety of game machines. A player inserts a coin or a specific token into a preferred game machine and enjoys a game.

Managing a game arcade involves grasping popular game machines, monitoring the operating states of game machines, and administering sales. Such management work is usually carried out after closing the game arcade by collecting coins from the game machines and checking the number of coins in each game machine.

A problem of such conventional machine management is that the states of game machines are obtainable only after collecting coins from each game machine.

There is a point-of-sale (POS) system capable of collecting sales data in real time. The POS system operates on management software. Developing management software involves an enormous cost if the software is intended to control a POS system that manages game arcades distributed nationwide. In this case, only persons having sufficient funds can afford to introduce nationwide POS systems. Any person having small funds is unable to employ a POS system to cover game arcades spreading in a wide area, or must employ the conventional management system.

Game arcades frequently change their states because they frequently introduce new game machines or replace unpopular game machines with others. Such changes must quickly be grasped and must be utilized to update the software to manage the game arcades that may be spread nationwide. Updating the management software is a difficult task to achieve for a game arcade management company.

### SUMMARY OF THE INVENTION

An object of the present invention is to provide a machine management system that allows even a person with limited funds to correctly manage game arcades spreading nationwide and always optimize management software.

A first aspect of the present invention provides a machine management system having a floor management unit to receive data on objective machines by radio and a master management unit to store application software containing know-how to manage the objective machines. The floor management unit downloads necessary application software from the master management unit through the Internet and manages the objective machines at any time according to the downloaded application software.

A second aspect of the present invention provides the machine management system of the first aspect with a database to store management and operation data concerning the objective machines. The floor management unit downloads necessary data from the database through the Internet and manages the objective machines at any time according to the downloaded data.

A third aspect of the present invention applies the machine management system of any one of the first and second aspects to managing game arcades. The objective machines are game machines each having a sensor to sense an inserted coin, a data holder to hold data based on an output of the sensor and identification data of the game machine, and a radio unit to transmit the data held in the data holder by radio. The floor management unit has a radio unit to receive the transmitted data from the game machines and a processing unit to process the received data according to the downloaded application software and/or the downloaded data.

A fourth aspect of the present invention relates to the machine management system of the third aspect. The game machines are provided with a collection unit and/or an exchange unit. Each of the collection unit and exchange unit has a sensor to sense collected or exchanged coins, a data holder to hold data based on an output of the sensor, and a radio unit to transmit the data held in the data holder. The radio unit of the floor management unit receives the transmitted data from the collection unit and/or the exchange unit, and the processing unit of the floor management unit processes the received data according to the downloaded application software and/or the downloaded data.

A fifth aspect of the present invention provides the machine management system of the second aspect with a management company's controller connectable to the Internet and a data center to receive, through the Internet, data automatically transmitted from the objective machines. The management company's controller downloads necessary application software from the master management unit and necessary data from the database and data center through the Internet, to manage the objective machines at any time.

According to the first aspect, the floor management unit downloads necessary application software from the master management unit through the Internet and manages the objective machines at any time according to the downloaded application software. With the downloaded application software and, for example, a wireless POS system, the floor management unit correctly manages the objective machines. The machine management system is realizable at reasonable cost even if the objective machines the system must manage are distributed among nationwide facilities. The machine management system is capable of properly managing the objective machines at any time. The application software may be updated by introducing new know-how into it. The updated application software is immediately downloadable by the floor management unit, to always properly manage the objective machines. Introducing new know-how into the application software is achievable by an application software provider who may collect improvements or changes from the nationwide facilities where the objective machines are installed. Without improving the application software by itself, a management company that manages the objective machines can always properly manage the objective machines according to the updated application software. The management company can rearrange or replace the objective machines at any time without interrupting the real-time grasping of, for example, sales data.

In addition to the effects of the first aspect, the second aspect employs the database to store management and operation data on the objective machines. The floor management unit downloads necessary data from the database through the Internet and manages the objective machines at any time according to the downloaded data. The floor management unit is not required to own the database, and therefore, the machine management system can be constructed at low cost.

In addition to the effects of the first and second aspects, the third aspect applies the machine management system to manage a game arcade involving game machines. Each game machine has a sensor to sense an inserted coin, a data holder to hold data based on an output of the sensor and identification data of the game machine, and a radio unit to transmit the data held in the data holder by radio. The floor management unit has a radio unit to receive the transmitted data from the game machines and a processing unit to process the received data according to downloaded application software and/or downloaded data. A management company that controls game arcades distributed nationwide can properly and economically manage game machines installed in the game arcades according to the application software that is easy to download.

In addition to the effects of the third aspect, the fourth aspect provides the game machines with a collection unit and/or an exchange unit. Each of the collection unit and exchange unit has a sensor to sense collected or exchanged coins, a data holder to hold data based on an output of the sensor, and a radio unit to transmit the data held in the data holder. The radio unit of the floor management unit receives the transmitted data from the collection unit and/or the exchange unit, and the processing unit of the floor management unit processes the received data according to downloaded application software and/or downloaded data. The fourth aspect optimally manages the game machines including the collection unit and exchange unit and enables game arcades to be expanded nationwide at low cost.

In addition to the effects of the first aspect, the fifth aspect automatically transmits data from the objective machines to the data center through the Internet and allows the management company's controller to download the data from the data center through the Internet. As a result, any of the game facilities spread nationwide can manage its game machines according to the downloaded data and application software. Staff of each game facility is free from sales compilation work, and therefore, can spare time for player service.

### BRIEF DESCRIPTION OF THE DRAWINGS

FIG. 1 is a block diagram showing a machine management system according to an embodiment of the present invention; and

FIG. 2 is a block diagram showing a floor management unit and a game machine in the machine management system.

### DETAILED DESCRIPTION OF EMBODIMENTS

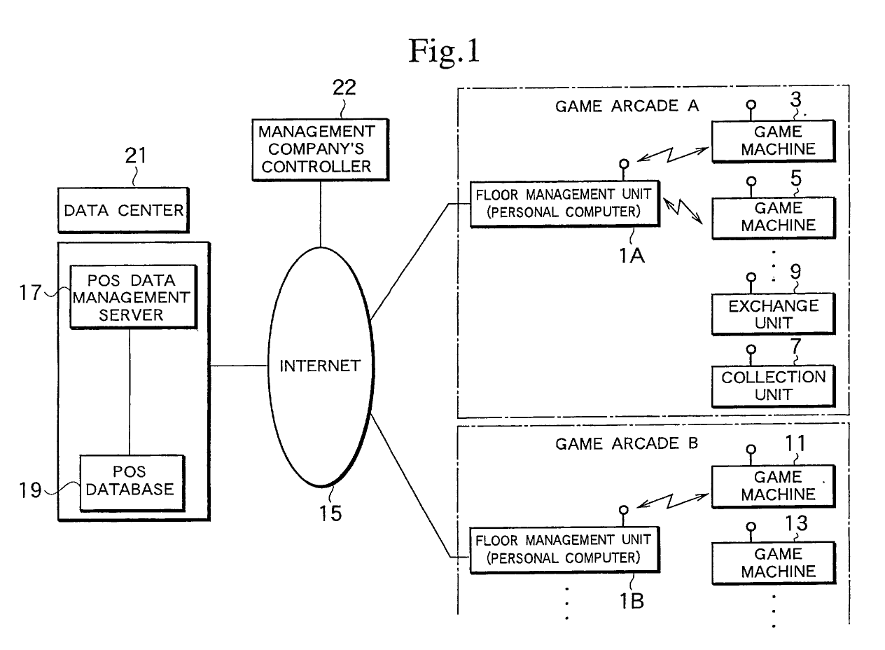

FIG. 1 is a block diagram showing a machine management system according to an embodiment of the present invention. The system of FIG. 1 serves as a game machine management system. The system involves game arcades A, B, and the like. These game arcades may be independent shops or floors each involving a sufficient space to secure small-power radio communication. The game arcades A, B, and the like are provided with floor management units 1A, 1B, and the like, respectively. In addition these game arcades A, B have game machines 3, 5, and the like serving as objective machines managed by the floor management unit 1A, game machines 11, 13, and the like serving as objective machines managed by the floor management unit 1B, respectively. Each game arcade has a mobile collection unit 7 (shown only in the game arcade A), and an exchange unit 9 (shown only in the game arcade A). Each game arcade employs radio communication to manage the game machines. The game arcades may be distributed nationwide.

Each floor management unit is connectable to a POS data management server 17 serving as a master management unit through the Internet 15. The POS data management server 17 is connected to a POS database 19. A data center 21 is connected to the Internet 15 through, for example, an exclusive line. A management company's controller 22 is also connectable to the Internet 15. The management company's controller 22 belongs to a management company that controls the game arcades A, B, and the like that may be spread nationwide.

Each floor management unit may employ a personal computer as a main processing unit.

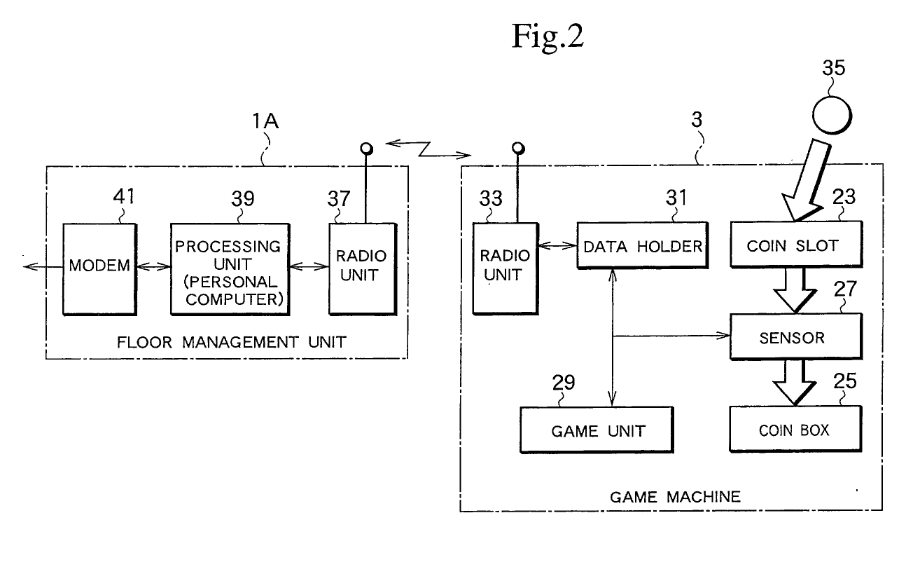

FIG. 2 shows the details of the floor management unit 1A and the game machine 3. The other floor management units, game machines, collection units, and exchange units installed in the game arcades A, B, and the like have similar structures.

The game machine 3 has a coin slot 23, a coin box 25, a sensor 27, a game unit 29, a data holder 31, and a radio unit 33.

The coin slot 23 is used by a player to insert a coin 35 to start a game. The coin 35 may be any other object such as a token. The sensor 27 senses the inserted coin. The coin box 25 accumulates inserted coins. The game unit 29 has a game board.

The data holder 31 has a counting function to count the number of ON operations of a contact of the sensor 27 that is turned on whenever a coin 35 is inserted into the coin slot 23, a memory function to store the counted number and an ID of the game machine 3, and a data clearing function to clear the stored data in response to an instruction signal. The data holder 31 may be a board installed in the game machine 3. The data holder 31 is provided with a backup power source to hold data during a power OFF period.

The radio unit 33 may be a power-saving radio device employing a standard radio subcarrier MKS modem IC. The radio unit 33 transmits the data held in the data holder 31 by radio and receives instruction signals from the floor management unit 1A by radio.

The floor management unit 1A has a radio unit 37, a data processing unit 39 such as a personal computer, and a communication modem 41. The radio unit 37 receives data from the game machines by radio and carries out data transmission. The processing unit 39 receives the radio-transmitted data from the game machines, downloads application software and data from the POS data management server 17 and POS database 19, and manages the game machines by radio according to the application software and data.

According to the embodiment, the processing unit 39 downloads necessary application software and data and processes data. Namely, the processing unit 39 keeps only basic software mainly made of menus. According to the downloaded application software and data, the floor management unit 1A gathers data from the game machines, processes the gathered data, and manages the game machines. The floor management unit 1A may have a data printout function.

The exchange unit 9 is one of the objective machines to be managed according to the embodiment. The exchange unit 9 has a sensor to sense an amount of exchanged money or the number of exchanged tokens, a data holder to hold an output of the sensor, and a radio unit to radio the data held in the data holder to the floor management unit IA.

The collection unit 7 is also one of the objective machines to be managed. According to the embodiment, the collection unit 7 can travel. The collection unit 7 has a counting mechanism serving as a sensor to sense collected coins to count the number of coins collected from each game machine, a reading mechanism to read an ID (a bar code) of each game machine, a data holder to hold outputs of the counting mechanism and reading mechanism, and a radio unit to radio the data held in the data holder to the floor management unit 1A.

The POS data management server 17 stores many pieces of application software containing machine management know-how. The application software is combined with radio communication to constitute a wireless point-of-sale (POS) system to grasp sales data of the game arcades A, B, and the like.

Each floor management unit downloads necessary application software from the POS data management server 17 through the Internet 15 and manages the game machines according to the downloaded application software. The POS data management server 17 serves as an application software service provider (ASP).

The application software pieces stored in the POS data management server 17 include software to control the game machines, collection units 7, and exchange units 9, software to manage the sales of the game machines and game arcades, and software to manage staff's state such as time of beginning and finishing with his/her work. These application software pieces contain high-level know-how to manage the game machines, etc.

The POS database 19 stores management and operation data concerning the game machines 3, 5, and the like. The data includes, for each game machine, a machine name (frame name), a game name (board name), the number of slots, a type, a fee (for example, 50 yen or 100 yen), a purchase date, a price, depreciation, dimensions, weight, parts replacement history, repair history, shop data, sales data, and the like.

Whenever a coin is inserted into a game machine, the game arcade in which the game machine is installed automatically transmits sales data to the data center 21 through the Internet 15 and exclusive line, and the data center 21 stores the transmitted data.

The management company's controller 22 has the same structure as the floor management unit 1A. The management company's controller 22 downloads necessary application software and data from the POS data management server 17, POS database 19, and data center 21 and carries out management tasks at any time according to the downloaded software and data. More precisely, the management company's controller 22 manages, collects, analyzes, and prints data of the floor management units 1A, 1B, and the like of the game arcades (or floors) A, B, and the like distributed nationwide.

Players in the game arcades play the game machines installed therein. The operation of any game machine, for example, the game machine 3 starts when a coin or a token is inserted into the game machine 3. The sensor 27 senses the inserted coin, and the data holder 31 counts inserted coins. The operation of the game machine 3 can be grasped and managed at any time.

At predetermine intervals, for example, every hour, or in response to an instruction signal with a machine ID from the floor management unit, the radio unit 33 of each game machine transmits count data with a machine ID. The floor management unit (such as the unit 1A) receives the transmitted data. Each floor management unit receives, sorts, and tallies up data from all game machines that are under the control of the floor management unit.

A staff member operates the floor management unit (such as the unit 1A), connects it to the Internet 15, and downloads necessary application software from the POS data management server 17 and necessary data from the POS database 19.

For example, the staff member downloads accounting software from the POS data management server 17 and data concerning machine names, game names, and fees from the POS database 19 and prints out an accounting book.

The similar operation may be carried out by the management company's controller 22. The data center 21 accumulates sales data that is automatically transmitted from each game arcade whenever a coin is inserted into a game machine. The management company's controller 22 accesses the POS data management server 17 and POS database 19 through the Internet 15 to download application software and data, accesses the data center 21 through the Internet to grasp sales data of the game machines of the nationwide game arcades, and manages the game machines and game arcades according to the data and application software.

Staff of the game arcades are not required to carry out sales data collecting work, and therefore, can spare time for game players. This results in greatly improving the environments of the game arcades.

The operating states of the game machines are easily grasped at any time according to the counts of coins without confirming the coins or tokens in the coin boxes of the game machines each time.

When any game arcade such as the game arcade A closes its daily business, the floor management unit 1A receives data from the exchange unit 9. At the same time, the collection unit 7 collects coins or tokens from each game machine, counts the total of the collected coins or tokens of each game machine, and transmits the totals with machine IDs to the floor management unit 1A. The floor management unit 1A downloads application software from the POS data management server 17 and data from the POS database 19 and data center 21 and checks to see if the data from the game machines agrees with the downloaded data.

In this way, each game arcade can download application software containing high-level know-how from the POS data management server 17, to manage the game machines. When setting up new game arcades, a management company of the game arcades is not required to develop application software because it can download the software from the POS data management server 17, and therefore, can set up new game arcades at low cost.

A nationwide POS system usually needs an initial investment of hundreds of millions of yen. According to the present invention, the machine management system needs only an initial investment for a wireless LAN system, and the application software containing high-level know-how is usable at a charge of about 3% of sales. According to the present invention, know-how in a specific business field can be contained in application software, and charges for the know-how can be collected as software fees. With such software, one can easily obtain advanced know-how, smoothly expedite business, and improve sales.

When introducing new know-how into the application software, the provider of the application software may pick up changes and improvements from the nationwide game arcades and use them to update the application software. The management company of the game arcades, therefore, is not required to improve the application software by itself and can use updated application software to manage the game arcades.

Game arcades frequently introduce new game machines or replace old game machines with popular game machines. Large game arcades have 200 to 300 game machines each. For such game arcades, introducing the machine management system of the present invention is advantageous in quickly starting the management of rearranged or replaced game machines.

The machine management system of the present invention is an ASP POS system that is a combination of an ASP and a wireless POS system. The present invention gives business fields under severe financial environments a chance to introduce a management technique that fully utilizes data.

What is claimed is:

1. A machine management system comprising:
a floor management unit to receive data on objective machines by radio; and
a master management unit to store application software containing know-how to manage the objective machines,
the floor management unit downloading necessary application software from the master management unit through the Internet and managing the objective machines at any time according to the downloaded application software.

2. The machine management system of claim 1, further comprising:
a database to store management and operation data concerning the objective machines,
the floor management unit downloading necessary data from the database through the Internet and managing the objective machines at any time according to the downloaded data.

3. The machine management system of claim 1, wherein:
the objective machines are game machines each having a sensor to sense an inserted coin, a data holder to hold data based on an output of the sensor and identification data of the game machine, and a radio unit to transmit the data held in the data holder by radio; and
the floor management unit has a radio unit to receive the transmitted data from the game machines and a processing unit to process the received data according to the downloaded application software and/or the downloaded data.

4. The machine management system of claim 2, wherein:
the objective machines are game machines each having a sensor to sense an inserted coin, a data holder to hold data based on an output of the sensor and identification data of the game machine, and a radio unit to transmit the data held in the data holder by radio; and
the floor management unit has a radio unit to receive the transmitted data from the game machines and a processing unit to process the received data according to the downloaded application software and/or the downloaded data.

5. The machine management system of claim 3, wherein:
the game machines are provided with a collection unit and/or an exchange unit, each of the collection unit and exchange unit having a sensor to sense collected or exchanged coins, a data holder to hold data based on an output of the sensor, and a radio unit to transmit the data held in the data holder; and
the radio unit of the floor management unit receives the transmitted data from the collection unit and/or the exchange unit, and the processing unit of the floor management unit processes the received data according to the downloaded application software and/or the downloaded data.

6. The machine management system of claim 4, wherein:
the game machines are provided with a collection unit and/or an exchange unit, each of the collection unit and exchange unit having a sensor to sense collected or exchanged coins, a data holder to hold data based on an output of the sensor, and a radio unit to transmit the data held in the data holder; and
the radio unit of the floor management unit receives the transmitted data from the collection unit and/or the exchange unit, and the processing unit of the floor management unit processes the received data according to the downloaded application software and/or the downloaded data.

7. The machine management system of claim 2, further comprising:
a management company's controller connectable to the Internet; and
a data center to receive, through the Internet, data automatically transmitted from the objective machines,
the management company's controller downloading necessary application software from the master management unit and necessary data from the database and data center through the Internet, to manage the objective machines at any time.
